(19) United States
(12) Patent Application Publication
(10) Pub. No.: US 2020/0143182 A1
(43) Pub. Date: May 7, 2020

(54) IN-VEHICLE PASSENGER DETECTION APPARATUS AND METHOD OF CONTROLLING THE SAME

(71) Applicant: Hyundai Mobis Co., Ltd., Seoul (KR)

(72) Inventor: Seung Jong Noh, Seoul (KR)

(21) Appl. No.: 16/676,354

(22) Filed: Nov. 6, 2019

(30) Foreign Application Priority Data
Nov. 7, 2018 (KR) 10-2018-0135689

(51) Int. Cl. G06K 9/00; B60Q 9/00; B60W 40/08

(52) U.S. Cl. CPC G06K 9/00838; B60Q 9/008; B60W 2040/0881; G06T 2207/30268; B60R 2300/10; B60W 40/08

(57) ABSTRACT

Disclosed herein are an in-vehicle passenger detection apparatus and a method of controlling the same. The in-vehicle passenger detection apparatus includes an IR camera configured to photograph seats in a vehicle from the top, a driving state detection unit configured to detect a driving state of the vehicle, a warning unit configured to warn of neglect of a passenger, and a control unit configured to receive a captured image within the vehicle from the IR camera, when the vehicle is determined to be parked or stopped in the driving state input from the driving state detection unit, to segment the captured image into regions of interest, to detect passengers in all seats by extracting characteristics of the passengers through a dedicated neural network for each region of interest, and then to output an alarm through the warning unit according to whether there is a neglected passenger.

### CROSS-REFERENCE TO RELATED APPLICATION

This application claims priority from and the benefit of Korean Patent Application No. 10-2018-0135689, filed on Nov. 7, 2018, which is hereby incorporated by reference for all purposes as if set forth herein.

### BACKGROUND

### Field

Exemplary embodiments relates to an in-vehicle passenger detection apparatus and a method of controlling the same, and more particularly, to an in-vehicle passenger detection apparatus, which detects a passenger in a vehicle based on an image and determines whether the passenger is neglected to warn of neglect of the passenger, and a method of controlling the same.

### Discussion of the Background

In general, various types of school vehicles such as a van or a bus are operated to transport children to their destination after picking up the children at appointed places while traveling on a predetermined course in educational facilities such as kindergartens, childcare facilities, schools, and academies.

Incidentally, these days, the bus is operated in a poor environment in which a driver must perform all operations from departure to arrival and act as an assistant in a special case.

As the role of the driver is so heavy, the driver often gets off with the children neglected in the bus the engine of which is stopped. In such a case, accidents often occur due to the rapid rise of temperature in a closed space within the vehicle during the hot summer season.

Accordingly, in order to solve this problem, a seating sensor or a voice sensor is installed in some cases in a passenger's seat to protect passengers when a driver is out of a vehicle with an elderly person or a child therein.

However, the seating sensor is problematic in that, even when an object is placed on the seat, it detects the object as a passenger and the voice sensor is problematic in that it may mistake a voice as external noise during detection and cannot detect a voice if there is no voice.

In addition, there is a problem in that, even when a search is performed based on an image, a passenger is detected differently according to the posture of the passenger and a newborn or an infant is not detected as the passenger.

The related art of the present invention is disclosed in Korean Patent No. 10-1478053 (published on Dec. 24, 2014, entitled “Safety System for Children's School Vehicle”).

The above information disclosed in this Background section is only for enhancement of understanding of the background of the invention and, therefore, it may contain information that does not constitute prior art.

### SUMMARY

Exemplary embodiments of the present invention are directed to an in-vehicle passenger detection apparatus that, when detecting a passenger in a vehicle based on an image, segments a region of interest according to the characteristics of the passenger, extracts the characteristics of the passenger through a dedicated neural network suitable for the characteristics in the segmented region of interest, and then fuses extracted characteristic information to detect the passenger as a final passenger, thereby improving detection performance, and determines whether the passenger is neglected to warn of neglect of the passenger, and a method of controlling the same.

In an embodiment, there is provided an in-vehicle passenger detection apparatus that includes an IR camera configured to photograph seats in a vehicle from the top, a driving state detection unit configured to detect a driving state of the vehicle, a warning unit configured to warn of neglect of a passenger, and a control unit configured to receive a captured image within the vehicle from the IR camera, when the vehicle is determined to be parked or stopped in the driving state input from the driving state detection unit, to segment the captured image into regions of interest, to detect passengers in all seats by extracting characteristics of the passengers through a dedicated neural network for each region of interest, and then to output an alarm through the warning unit according to whether there is a neglected passenger.

The IR camera may include a fisheye lens having a wide viewing angle.

The control unit may segment the captured image into a normal region of interest for detecting a passenger who does not use a car seat and a passenger who is seated in a normal position and a normal posture, an abnormal region of interest for detecting a passenger who is in an abnormal posture and an abnormal position, and an infant region of interest for detecting a passenger who uses a car seat.

The control unit may set the normal region of interest by normalizing each seat image of the captured image to a predetermined normal size.

The control unit may set the abnormal region of interest by normalizing a back seat image of the captured image to a predetermined abnormal size.

The control unit may set the infant region of interest by normalizing a back seat image of the captured image to a predetermined infant size.

The control unit may detect the passengers by extracting the characteristics of the passengers using a convolutional neural network for each region of interest and then fusing correlation information of the extracted characteristics using a fully connected neural network.

When a passenger in another seat is detected over a predetermined time with a driver out of the vehicle as a result of detecting the passengers, the control unit may determine that the passenger is neglected.

The in-vehicle passenger detection apparatus may further include a wireless communication unit configured such that the control unit outputs the alarm to a driver's mobile communication terminal through the wireless communication unit when the neglected passenger is detected.

The control unit may output the alarm to a vehicle control unit to operate an air conditioner.

In an embodiment, there is provided a method of controlling an in-vehicle passenger detection apparatus, which includes inputting a captured image within a vehicle to a control unit from an IR camera when the vehicle is determined to be parked or stopped in a driving state input to the control unit, detecting passengers in all seats by segmenting the captured image into regions of interest and extracting characteristics of the passengers through a dedicated neural network for each region of interest by the control unit, determining whether there is a neglected passenger after detecting the passenger by the control unit, and outputting an alarm according to the determining whether there is a neglected passenger by the control unit.

When the captured image is segmented into the regions of interest in the detecting passengers, the control unit may segment the captured image into a normal region of interest for detecting a passenger who does not use a car seat and a passenger who is seated in a normal position and a normal posture, an abnormal region of interest for detecting a passenger who is in an abnormal posture and an abnormal position, and an infant region of interest for detecting a passenger who uses a car seat.

The normal region of interest may be set by normalizing each seat image of the captured image to a predetermined normal size by the control unit.

The abnormal region of interest may be set by normalizing a back seat image of the captured image to a predetermined abnormal size by the control unit.

The infant region of interest may be set by normalizing a back seat image of the captured image to a predetermined infant size by the control unit.

In the detecting passengers, the control unit may detect the passengers by extracting the characteristics of the passengers using a convolutional neural network for each region of interest and then fusing correlation information of the extracted characteristics using a fully connected neural network.

In the determining whether there is a neglected passenger, when a passenger in another seat is detected over a predetermined time with a driver out of the vehicle, as a result of detecting the passengers, the control unit may determine that the passenger is neglected.

In the outputting an alarm, the control unit may output the alarm to a driver's mobile communication terminal through a wireless communication unit.

In the outputting an alarm, the control unit may output the alarm to a vehicle control unit to operate an air conditioner.

As apparent from the above description, the in-vehicle passenger detection apparatus and the method of controlling the same according to exemplary embodiments of the present invention, when detecting a passenger in the vehicle based on the image, segment the region of interest according to the characteristics of the passenger, extract the characteristics of the passenger through the dedicated neural network suitable for the characteristics in the segmented region of interest, and then fuse the extracted characteristic information to detect the passenger as a final passenger. Therefore, it is possible to not only improve detection performance regardless of the posture or age of the passenger or the like to minimize the occurrence of the false alarm, but also accurately determine whether the passenger is neglected and warn of the neglect of the passenger to prevent the accident caused by the neglected passenger.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an in-vehicle passenger detection apparatus according to an embodiment of the present invention.

FIG. 2 is a view illustrating a region of interest for detecting a passenger in the in-vehicle passenger detection apparatus according to the embodiment of the present invention.

FIG. 3 is a view illustrating a neural network structure for detecting a passenger in the in-vehicle passenger detection apparatus according to the embodiment of the present invention.

FIG. 4 is a view illustrating a process of detecting a passenger by fusing characteristic information of the passenger in the in-vehicle passenger detection apparatus according to the embodiment of the present invention.

FIG. 5 is a flowchart for explaining a method of controlling an in-vehicle passenger detection apparatus according to an embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Hereinafter, an in-vehicle passenger detection apparatus and a method of controlling the same according to the present invention will be described below in detail with reference to the accompanying drawings through various examples of embodiments. It should be noted that the drawings are not necessarily to scale and may be exaggerated in thickness of lines or sizes of components for clarity and convenience of description. Furthermore, the terms as used herein are terms defined in consideration of functions of the invention and may change depending on the intention or practice of a user or an operator. Therefore, these terms should be defined based on the overall disclosures set forth herein.

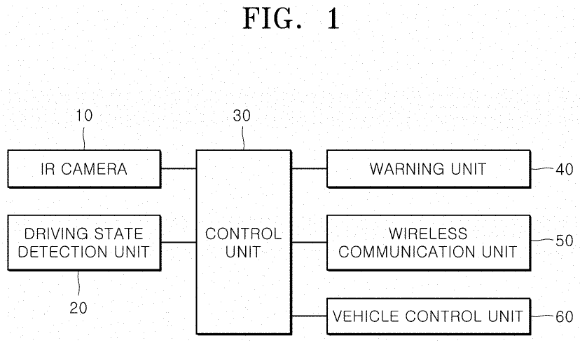

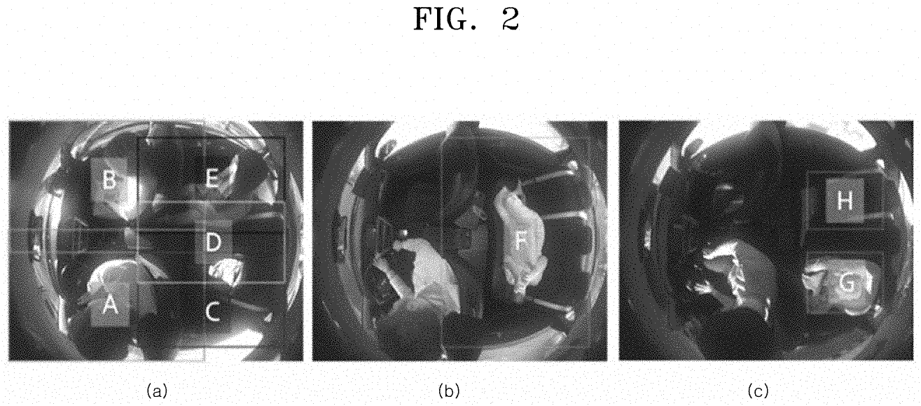

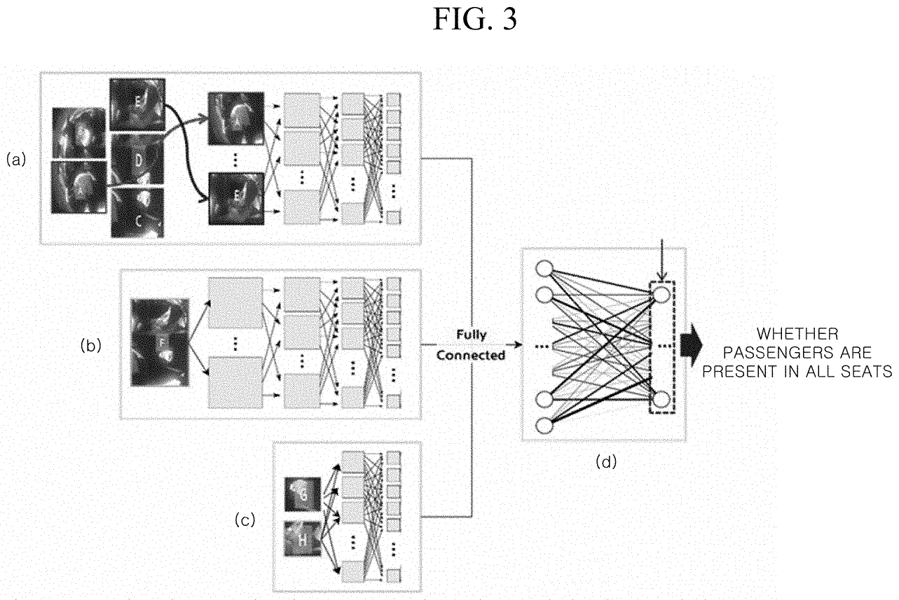

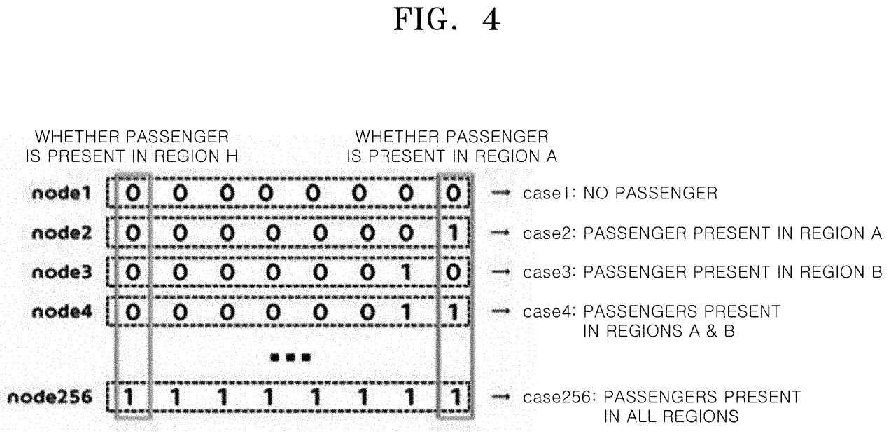

FIG. 1 is a block diagram illustrating an in-vehicle passenger detection apparatus according to an embodiment of the present invention. FIG. 2 is a view illustrating a region of interest for detecting a passenger in the in-vehicle passenger detection apparatus according to the embodiment of the present invention. FIG. 3 is a view illustrating a neural network structure for detecting a passenger in the in-vehicle passenger detection apparatus according to the embodiment of the present invention. FIG. 4 is a view illustrating a process of detecting a passenger by fusing characteristic information of the passenger in the in-vehicle passenger detection apparatus according to the embodiment of the present invention.

As illustrated in FIG. 1, the in-vehicle passenger detection apparatus according to the embodiment of the present invention may include an IR camera 10, a driving state detection unit 20, a warning unit 40, a control unit 30, and a wireless communication unit 50.

The IR camera 10 photographs seats in a vehicle from the top and provides a captured image to the control unit 30.

The IR camera 10 may be equipped with a fisheye lens having a wide viewing angle to photograph all the seats in the vehicle through a single camera.

The driving state detection unit 20 detects the driving state of the vehicle to provide it to the control unit 30 so that the control unit 30 may determine whether the vehicle is parked or stopped.

The warning unit 40 warns a driver to recognize neglect of a passenger.

The warning unit 40 may be provided in a cluster of the vehicle to output a warning screen or sound.

The control unit 30 may receive the captured image within the vehicle from the IR camera 10, when the vehicle is determined to be parked or stopped in the driving state input from the driving state detection unit 20, to segment the captured image into regions of interest.

The regions of interest may be defined as illustrated in FIG. 2.

That is, as illustrated in FIG. 2(a), the control unit 30 may set a normal region of interest for detecting a passenger who does not use a car seat and a passenger who is seated in a normal position and a normal posture by normalizing each seat image of the captured image to a predetermined normal size.

For example, the control unit 30 may set five normal regions of interest of A to E by normalizing the image to a 224×224 size.

In addition, as illustrated in FIG. 2(b), the control unit 30 may set an abnormal region of interest for detecting a passenger who is in an abnormal posture and an abnormal position, for example, who is seated across two seats or lies down or stands up, by normalizing the back seat image of the captured image to a predetermined abnormal size.

For example, the control unit 30 may set an abnormal region of interest of F by normalizing the image to a 448×224 size.

In addition, as illustrated in FIG. 2(c), the control unit 30 may set an infant region of interest for detecting an infant passenger who is smaller than an adult or uses a car seat by normalizing the back seat image of the captured image to a predetermined infant size.

For example, the control unit 30 may set infant regions of interest of G and H by normalizing the image to a 112×112 size.

The control unit 30 may detect the passengers in all seats by setting the regions of interest for the captured image and then extracting the characteristics of the passengers through the dedicated neural network for each region of interest.

As illustrated in FIG. 3, the control unit 30 may detect a passenger by extracting the characteristics of the passenger using a convolutional neural network for each region of interest and then fusing correlation information of the extracted characteristics using a fully connected neural network.

FIG. 3(a) illustrates that a normal passenger characteristic map is output through a neural network to extract the characteristics of a passenger in a normal region of interest. FIG. 3(b) illustrates that an abnormal passenger characteristic map is output to extract the characteristics of a passenger in an abnormal region of interest. FIG. 3(c) illustrates that an infant passenger characteristic map is output to extract the characteristics of a passenger in an infant region of interest. Then, FIG. 3(d) illustrates that passengers in all seats may be detected based on the probability values for passenger occupancy situations by receiving the normal passenger characteristic map, the abnormal passenger characteristic map, and the infant passenger characteristic map and modeling correlation information through a fully connected neural network.

That is, as illustrated in FIG. 4, it is possible to detect a passenger by fusing characteristic maps extracted from respective regions of interest and defining a probability value for each node to determine whether the passenger is present in the vehicle.

The control unit 30 may determine whether a passenger is neglected after detecting the passenger as described above and output an alarm through the warning unit 40.

When a passenger in another seat is detected over a predetermined time with a driver out of a vehicle, as a result of detecting the passengers, the control unit 30 may determine that the passenger is neglected and output an alarm.

The control unit 30 may output an alarm to a vehicle control unit 60 to operate an air conditioner or the like, thereby preventing a secondary accident caused by neglected passengers.

When the neglected passenger is detected, the control unit 30 may output an alarm to a driver's mobile communication terminal through the wireless communication unit 50 so that the driver may recognize and cope with the situation of the vehicle even when the driver is at a long distance.

As described above, the in-vehicle passenger detection apparatus according to the embodiment of the present invention, when detecting a passenger in the vehicle based on the image, segments the region of interest according to the characteristics of the passenger, extracts the characteristics of the passenger through the dedicated neural network suitable for the characteristics in the segmented region of interest, and then fuses the extracted characteristic information to detect the passenger as a final passenger. Therefore, it is possible to not only improve detection performance regardless of the posture or age of the passenger or the like to minimize the occurrence of the false alarm, but also accurately determine whether the passenger is neglected and warn of the neglect of the passenger to prevent the accident caused by the neglected passenger.

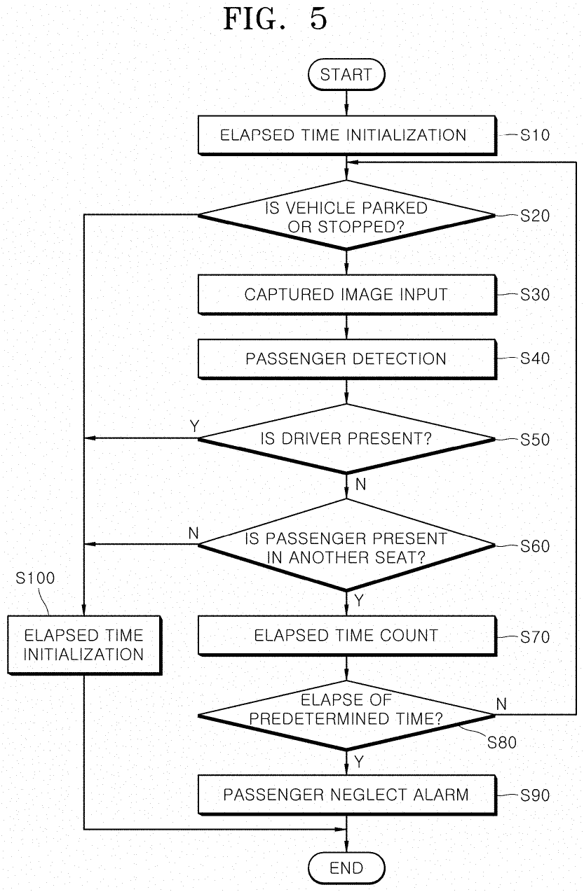

FIG. 5 is a flowchart for explaining a method of controlling an in-vehicle passenger detection apparatus according to an embodiment of the present invention.

As illustrated in FIG. 5, in the method of controlling an in-vehicle passenger detection apparatus according to the embodiment of the present invention, first, a control unit 30 initializes an elapsed time when an in-vehicle passenger detection apparatus begins to operate (S10).

After initializing the elapsed time in step S10, the control unit 30 receives a driving state of a vehicle from a driving state detection unit 20 and determines whether the vehicle is parked or stopped (S20).

When the vehicle is not parked or stopped as a result of determining whether the vehicle is parked or stopped in step S20, namely, when the vehicle is driven, the control unit 30 initializes the elapsed time (S100).

That is, since it may be determined that the passenger is not neglected when the vehicle is driven, the counted elapsed time may be initialized.

When the vehicle is parked or stopped as a result of determining whether the vehicle is parked or stopped in step S20, the control unit 30 receives a captured image from an IR camera 10 (S30).

After receiving the captured image in step S30, the control unit segments the captured image into regions of interest and detects passengers in all seats by extracting the characteristics of the passengers through a dedicated neural network for each region of interest (S40).

The regions of interest may be defined as illustrated in FIG. 2.

That is, as illustrated in FIG. 2(a), the control unit 30 may set a normal region of interest for detecting a passenger who does not use a car seat and a passenger who is seated in a normal position and a normal posture by normalizing each seat image of the captured image to a predetermined normal size.

For example, the control unit 30 may set five normal regions of interest of A to E by normalizing the image to a 224×224 size.

In addition, as illustrated in FIG. 2(b), the control unit 30 may set an abnormal region of interest for detecting a passenger who is in an abnormal posture and an abnormal position, for example, who is seated across two seats or lies down or stands up, by normalizing the back seat image of the captured image to a predetermined abnormal size.

For example, the control unit 30 may set an abnormal region of interest of F by normalizing the image to a 448×224 size.

In addition, as illustrated in FIG. 2(c), the control unit 30 may set an infant region of interest for detecting an infant passenger who is smaller than an adult or uses a car seat by normalizing the back seat image of the captured image to a predetermined infant size.

For example, the control unit 30 may set infant regions of interest of G and H by normalizing the image to a 112×112 size.

The control unit 30 may detect the passengers in all seats by setting the regions of interest for the captured image as described above and then extracting the characteristics of the passengers through the dedicated neural network for each region of interest.

As illustrated in FIG. 3, the control unit 30 may detect a passenger by extracting the characteristics of the passenger using a convolutional neural network for each region of interest and then fusing correlation information of the extracted characteristics using a fully connected neural network.

FIG. 3(a) illustrates that a normal passenger characteristic map is output through a neural network to extract the characteristics of a passenger in a normal region of interest. FIG. 3(b) illustrates that an abnormal passenger characteristic map is output to extract the characteristics of a passenger in an abnormal region of interest. FIG. 3(c) illustrates that an infant passenger characteristic map is output to extract the characteristics of a passenger in an infant region of interest. Then, FIG. 3(d) illustrates that passengers in all seats may be detected based on the probability values for passenger occupancy situations by receiving the normal passenger characteristic map, the abnormal passenger characteristic map, and the infant passenger characteristic map and modeling correlation information through a fully connected neural network.

That is, as illustrated in FIG. 4, it is possible to detect a passenger by fusing characteristic maps extracted from respective regions of interest and defining a probability value for each node to determine whether the passenger is present in the vehicle.

After detecting the passengers in step S40, the control unit 30 determines whether the driver is present in the vehicle (S50).

When the driver is present in the vehicle as a result of determining whether the driver is present in the vehicle in step S50, the control unit 30 initializes the elapsed time and then ends the process (S100).

On the other hand, when the driver is not present in the vehicle as a result of determining whether the driver is present in the vehicle in step S50, the control unit 30 determines whether a passenger is present in another seat (S60).

When the passenger is not present as a result of determining whether a passenger is present in the other seat in step S60, the control unit 30 initializes the elapsed time and then ends the process (S100).

On the other hand, when the passenger is present as a result of determining whether a passenger is present in the other seat in step S60, the control unit 30 counts the elapsed time (S70).

After counting the elapsed time in step S70, the control unit 30 determines whether the elapsed time exceeds a predetermined time (S80).

When it is determined that the elapsed time does not exceed the predetermined time in step S80, the control unit 30 returns to step S20 to determine the driving state of the vehicle, When the vehicle is parked or stopped, the control unit 30 repeats the above process to determine whether the passenger is neglected while counting the elapsed time.

When it is determined in step S80 that the elapsed time exceeds the predetermined time, the control unit 30 outputs a passenger neglect alarm through a warning unit 40 (S90).

When outputting the passenger neglect alarm in step S90, the control unit 30 may output the alarm to a vehicle control unit 60 to operate an air conditioner or the like, thereby preventing a secondary accident caused by neglected passengers.

Meanwhile, when the neglected passenger is detected, the control unit 30 may output an alarm to a driver's mobile communication terminal through a wireless communication unit 50 so that the driver may recognize and cope with the situation of the vehicle even when the driver is at a long distance.

As described above, the method of controlling an in-vehicle passenger detection apparatus according to the embodiment of the present invention, when detecting a passenger in the vehicle based on the image, segments the region of interest according to the characteristics of the passenger, extracts the characteristics of the passenger through the dedicated neural network suitable for the characteristics in the segmented region of interest, and then fuses the extracted characteristic information to detect the passenger as a final passenger. Therefore, it is possible to not only improve detection performance regardless of the posture or age of the passenger or the like to minimize the occurrence of the false alarm, but also accurately determine whether the passenger is neglected and warn of the neglect of the passenger to prevent the accident caused by the neglected passenger.

While various embodiments have been described above, it will be understood by those skilled in the art that the embodiments described are by way of example only. It will be apparent to those skilled in the art that various modifications and other equivalent embodiments may be made without departing from the spirit and scope of the disclosure. Accordingly, the true technical protection scope of the invention should be defined by the appended claims.

What is claimed is:

1. An in-vehicle passenger detection apparatus comprising:
an IR camera configured to photograph seats in a vehicle from the top;
a driving state detection unit configured to detect a driving state of the vehicle;
a warning unit configured to warn of neglect of a passenger; and
a control unit configured to receive a captured image within the vehicle from the IR camera, when the vehicle is determined to be parked or stopped in the driving state input from the driving state detection unit, to segment the captured image into regions of interest, to detect passengers in all seats by extracting characteristics of the passengers through a dedicated neural network for each region of interest, and then to output an alarm through the warning unit according to whether there is a neglected passenger.

2. The in-vehicle passenger detection apparatus according to claim 1, wherein the IR camera comprises a fisheye lens having a wide viewing angle.

3. The in-vehicle passenger detection apparatus according to claim 1, wherein the control unit segments the captured image into a normal region of interest for detecting a passenger who does not use a car seat and a passenger who is seated in a normal position and a normal posture, an abnormal region of interest for detecting a passenger who is in an abnormal posture and an abnormal position, and an infant region of interest for detecting a passenger who uses a car seat.

4. The in-vehicle passenger detection apparatus according to claim 3, wherein the control unit sets the normal region of interest by normalizing each seat image of the captured image to a predetermined normal size.

5. The in-vehicle passenger detection apparatus according to claim 3, wherein the control unit sets the abnormal region of interest by normalizing a back seat image of the captured image to a predetermined abnormal size.

6. The in-vehicle passenger detection apparatus according to claim 3, wherein the control unit sets the infant region of interest by normalizing a back seat image of the captured image to a predetermined infant size.

7. The in-vehicle passenger detection apparatus according to claim 1, wherein the control unit detects the passengers by extracting the characteristics of the passengers using a convolutional neural network for each region of interest and then fusing correlation information of the extracted characteristics using a fully connected neural network.

8. The in-vehicle passenger detection apparatus according to claim 1, wherein, when a passenger in another seat is detected over a predetermined time with a driver out of the vehicle as a result of detecting the passengers, the control unit determines that the passenger is neglected.

9. The in-vehicle passenger detection apparatus according to claim 1, further comprising a wireless communication unit configured such that the control unit outputs the alarm to a driver's mobile communication terminal through the wireless communication unit when the neglected passenger is detected.

10. The in-vehicle passenger detection apparatus according to claim 1, wherein the control unit outputs the alarm to a vehicle control unit to operate an air conditioner.

11. A method of controlling an in-vehicle passenger detection apparatus, comprising:
inputting a captured image within a vehicle to a control unit from an IR camera when the vehicle is determined to be parked or stopped in a driving state input to the control unit;
detecting passengers in all seats by segmenting the captured image into regions of interest and extracting characteristics of the passengers through a dedicated neural network for each region of interest by the control unit;
determining whether there is a neglected passenger after detecting the passenger by the control unit; and
outputting an alarm according to the determining whether there is a neglected passenger by the control unit.

12. The method according to claim 11, wherein when the captured image is segmented into the regions of interest in the detecting passengers, the control unit segments the captured image into a normal region of interest for detecting a passenger who does not use a car seat and a passenger who is seated in a normal position and a normal posture, an abnormal region of interest for detecting a passenger who is in an abnormal posture and an abnormal position, and an infant region of interest for detecting a passenger who uses a car seat.

13. The method according to claim 12, wherein the normal region of interest is set by normalizing each seat image of the captured image to a predetermined normal size by the control unit.

14. The method according to claim 12, wherein the abnormal region of interest is set by normalizing a back seat image of the captured image to a predetermined abnormal size by the control unit.

15. The method according to claim 12, wherein the infant region of interest is set by normalizing a back seat image of the captured image to a predetermined infant size by the control unit.

16. The method according to claim 11, wherein, in the detecting passengers, the control unit detects the passengers by extracting the characteristics of the passengers using a convolutional neural network for each region of interest and then fusing correlation information of the extracted characteristics using a fully connected neural network.

17. The method according to claim 11, wherein, in the determining whether there is a neglected passenger, when a passenger in another seat is detected over a predetermined time with a driver out of the vehicle as a result of detecting the passengers, the control unit determines that the passenger is neglected.

18. The method according to claim 11, wherein, in the outputting an alarm, the control unit outputs the alarm to a driver's mobile communication terminal through a wireless communication unit.

19. The method according to claim 11, wherein, in the outputting an alarm, the control unit outputs the alarm to a vehicle control unit to operate an air conditioner.
